(19) United States
(12) Patent Application Publication
(10) Pub. No.: US 2008/0180254 A1
(43) Pub. Date: Jul. 31, 2008

(54) CIRCULARLY-POLARIZED RFID TAG ANTENNA STRUCTURE

(76) Inventor: JOHN A. KAJANDER, Dallas, TX (US)

Correspondence Address: William Kempler;Texas Instruments Incorporated, M/S 3999, PO Box 655474, Dallas, TX, 75265, US

(21) Appl. No.: 11/958,845

(22) Filed: Dec. 18, 2007

Related U.S. Application Data
(60) Provisional application No. 60/887,425, filed on Jan. 31, 2007.

(51) Int. Cl. G08B 13/14

(52) U.S. Cl. 340/572.7

(57) ABSTRACT

One embodiment of the invention includes an antenna structure for a passive radio-frequency identification (RFID) tag. The antenna structure comprises a first planar antenna element and a second planar antenna element that is coplanar with the first planar antenna element. The first and second planar antenna elements can be configured to receive circularly-polarized RF interrogation signals and to generate circularly-polarized RF signals having an axial ratio (AR) of less than 5 dB for transmission.

### RELATED APPLICATION

The present invention claims the benefit of U.S. Provisional Patent Application No. 60/887,425, filed Jan. 31, 2007, entitled “CIRCULATOR POLARIZED UHF PASSIVE RFID TAG WITH SINGLE-ENDED RF INPUT,” which is incorporated herein by reference.

### TECHNICAL FIELD

This invention relates to antennas, and more specifically to a circularly-polarized radio-frequency identification (RFID) tag antenna structure.

### BACKGROUND

Radio frequency identification (RFID) has become an increasingly important technology with a large variety of implementations, such as security and inventory. In a typical RFID system, an RFID reader continuously emits an RF interrogation signal. An RFID tag that is within the vicinity can receive the RF interrogation signal using an RF antenna. The received RF interrogation signal can be processed within an integrated circuit (IC) within the RFID tag, and the RFID tag can transmit a response signal via the RF antenna to the RFID reader. The response signal can include identification information about the RFID tag, such as based on a unique code. In a passive RFID tag, the processing and the generation of the response signal can be powered by storing and releasing the energy of the received RF interrogation signal, such as via a capacitor. As a result, passive RFID tags can be manufactured without an active power source, thus permitting the manufacture of RFID tags with a small form-factor.

Typical RFID tags include linearly polarized antennas. The RF interrogation signal that is continuously transmitted by the RFID reader can typically be circularly-polarized to provide for greater signal coverage. However, such an arrangement can provide a polarization mismatch between the RFID reader and a linearly polarized RFID tag. As an example, a linearly polarized antenna that is oriented 45° relative to the orthogonal signals that generate the circular polarization can experience a signal loss of approximately 3 dB, and thus may only receive approximately half the radiating power that is delivered by the RFID reader.

### SUMMARY

One embodiment of the invention provides an antenna structure for a passive radio-frequency identification (RFID) tag. The antenna structure includes a first planar antenna element and a second planar antenna element that is coplanar with the first planar antenna element. The first and second planar antenna elements are configured to propagate circularly-polarized electromagnetic signals with an axial ratio (AR) of less than 5 dB.

Another embodiment of the invention provides an antenna structure for a passive radio-frequency identification (RFID) tag. The antenna structure includes a first dipole antenna element and a second dipole antenna element that is substantially coplanar with and oriented orthogonal relative to the first antenna element, the second dipole antenna element being configured to provide an approximately 90° phase-shift relative to the first antenna element for radio frequency (RF) signals propagating in the first and second dipole antenna elements. A power combiner element configured as an interface interconnecting the first and second antenna elements and an RF input/output (I/O) port of the antenna structure.

Another embodiment of the invention provides a radio frequency identification (RFID) transponder that includes a substantially planar antenna structure. The antenna structure includes a phase-shift network that includes at least one pair of cross dipole antenna elements configured to propagate a circularly-polarized electromagnetic signals with an axial ratio (AR) of less than about 5 dB. The antenna structure also includes a power combiner connected to each of the antenna elements to provide an interface between the antenna structure and an input/output I/O port of the antenna structure. An integrated circuit (IC) includes a single I/O port that is electrically coupled with the I/O port of the antenna structure. The IC is configured to send and receive RF signals relative to antenna structure via the single I/O port thereof which propagate as the circularly-polarized electromagnetic waves in the antenna structure.

### BRIEF DESCRIPTION OF THE DRAWINGS

FIG. 1 illustrates an example of a radio frequency identification (RFID) tag in accordance with an aspect of the invention.

FIG. 2 illustrates an example of an RFID system in accordance with an aspect of the invention.

FIG. 3 illustrates an example of an RFID antenna structure in accordance with an aspect of the invention.

FIG. 4 illustrates another example of an RFID antenna structure in accordance with an aspect of the invention.

### DETAILED DESCRIPTION

The invention relates to electronic circuits, and more specifically to a circularly-polarized radio-frequency identification (RFID) tag antenna structure. The RFID tag antenna structure can include two antenna elements, which can be configured as dipole elements. The antenna elements can be configured coplanar relative to each other. The two antenna elements can be configured as a phase-shift network for signals that are received and transmitted to and from the antenna structure. As an example, one of the antenna elements can include an inductive element configured to provide a phase-shift of approximately 90° relative to the other antenna element. As a result, the antenna structure can provide an axial ratio of less than or equal to about 5 dB for waves within a frequency band of interest. As an example where the antenna structure is utilized in conjunction with a RFID reader, circularly-polarized RF interrogation signals can be received by the antenna structure at substantially any physical orientation angle relative to the RFID reader with minimal losses. In addition, based on reciprocity, RF response signals that are generated by the RFID tag are likewise transmitted via the antenna structure as circularly-polarized signals back to the RFID reader.

The RFID tag antenna structure can include a power combiner element that is integrally formed with the antenna elements. Thus, the power combiner element can be coplanar with both of the antenna elements. The power combiner element can be configured, for example, as a Wilkinson combiner, and can operate as an interface between the antenna elements and an input/output (I/O) port of an associated RF integrated circuit (IC). As an example, the power combiner element can be configured to combine the energy from each of the antenna elements to the I/O port for received circularly-polarized RF signals, and can distribute the energy of an RF response signal to each of the antenna elements for transmission of a circularly-polarized RF response signal. The antenna structure can also include one or more inductive elements and/or resistive elements to provide impedance matching between the power combiner element and the antenna elements. Furthermore, the antenna structure can include one or more capacitive elements to provide a distributed capacitance for a bandwidth that spans substantially all of the RFID frequency range (i.e., approximately 860-960 MHz).

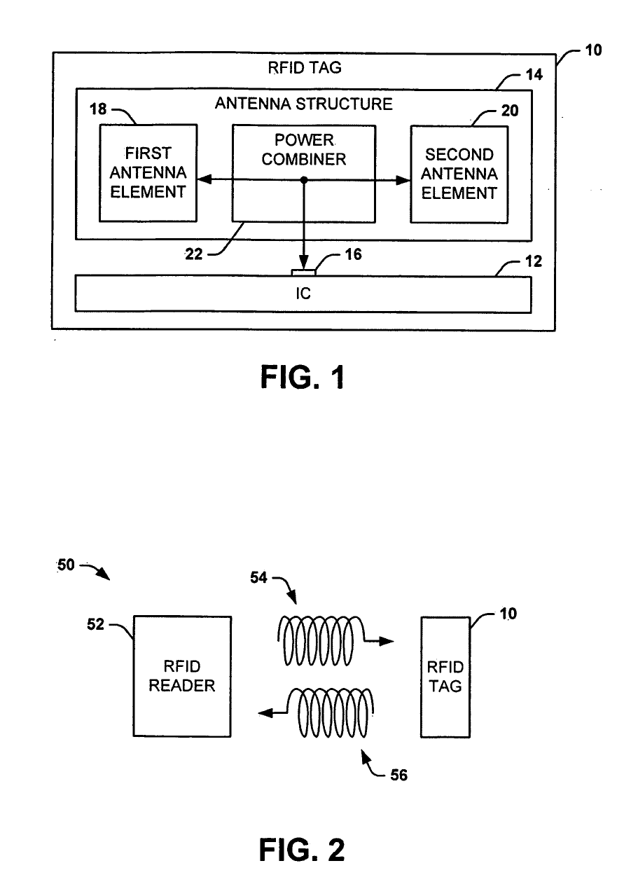

FIG. 1 illustrates an example of an RFID tag 10 in accordance with an aspect of the invention. The RFID tag 10 can be configured as a passive RFID tag. The RFID tag 10 includes an IC 12 that can include signal processing circuitry, memory and power storage circuitry, such as a capacitor. As an example, the IC 12 can be configured to process received RF interrogation signals that are transmitted from an RFID reader (not shown). The RFID tag 10 can thus generate RF response signals based on code and instructions in the memory in response to the received RF interrogation signals. As an example, the IC 12 can include a unique code corresponding to the RFID tag 10, which can thus be transmitted to an RFID reader (not shown) from which the RF interrogation signals were generated. As a result, the RFID tag 10 can permit secured access to a user of the RFID tag 10, can provide an inventory count of an item to which the RFID tag 10 is affixed, or can signal the RFID reader for any of a variety of other RFID applications.

The RFID tag 10 can receive the RF interrogation signals and transmit the RF response signals via an antenna structure 14. The antenna structure 14 can be physically configured to have circular polarization characteristics, such that the antenna structure propagates circularly-polarized electromagnetic signals. That is, the antenna structure 14 is configured to receive and transmit circularly-polarized RF signals. For example, the antenna structure can include one or more pairs of antenna elements 18 and 20, which can be configured as cross dipole elements. The cross dipole elements can be configured to propagate circularly-polarized RF signals with a predetermined phase shift. Specifically, a rotating electromagnetic field with a predetermined phase shift (e.g., 90° phase shift) is generated within the elements 18 and 20 of the antenna structure 14 upon receiving a circularly-polarized RF interrogation signal. Since the RF interrogation signals that are generated from a given RFID reader are typically circularly-polarized, the antenna structure 14 can be configured to receive circularly-polarized RF interrogation signals with the same polarization attributes as the reader. Due to corresponding reduced polarization and orientation losses, the RFID tag 10 can receive an interrogation signal scan at substantially any physical orientation of the RFID tag 10 relative to the reader. The antenna structure 14 can also radiate circularly-polarized electromagnetic signals received from the IC 12 via the I/O port thereof.

As demonstrated in the example of FIG. 1, the IC 12 is coupled to antenna structure 14 at an input/output (I/O) port 16. Therefore, the received circularly-polarized RF interrogation signals are received at the IC 12 via the I/O port 16. The I/O port can be a single IC port of the IC that can be coupled to a corresponding I/O port of the antenna structure 14. Upon processing the circularly-polarized RF interrogation signals, the IC 12 can generate an RF response signal that is provided to the antenna structure 14 via the I/O port 16. As a result, due to reciprocity, the antenna structure 14 is likewise configured to radiate the RF response signal as a rotating electromagnetic field (e.g., also having the same phase shift) that propagates in the elements of the antenna structure. This results in a circularly-polarized RF response signal that can be transmitted from the antenna structure 14 of the RFID tag 10 back to the RFID reader.

FIG. 2 illustrates an example of an RFID system 50 in accordance with an aspect of the invention. The RFID system 50 includes an RFID reader 52 configured to substantially continuously generate and transmit a circularly-polarized RF interrogation signal 54. As an example, the RFID reader 52 can generate the circularly-polarized RF interrogation signal 54 at each of a rapidly pulsed interval. The circularly-polarized RF interrogation signal 54 can be transmitted from the reader 52 at any of a variety of frequencies across the RFID spectrum (i.e., 860-960 MHz), and can have an axial ratio (AR) of between approximately 0.5 dB and 3.0 dB. The AR defines that ratio of the major and minor axes of a given circularly-polarized RF signal.

The RFID system 50 also includes the RFID tag 10, such as described in the example of FIG. 1. As described above, the RFID tag 10 is configured to receive the circularly-polarized RF interrogation signal 54 via the antenna structure 14. Specifically, the circularly-polarized RF interrogation signal 54 is received at the dipole elements as to generate a rotating electromagnetic field within the antenna structure 14. The configuration of the antenna structure 14 helps to mitigate power losses that might otherwise occur based on differing orientations of the RFID tag 10 relative to the RFID reader 52. In addition, based on reciprocity, the RFID tag 10 is likewise able to transmit a circularly-polarized RF response signal 56 via the antenna structure 14 according to the RF response generated by the IC 12 that is coupled to the antenna structure via the port 16.

Based on the structure of the antenna structure 14, the circularly-polarized RF signals propagating in the cross dipole antenna elements 18 and 20 (due to the RF interrogation signal or the response signal 56) can have an AR of approximately 5 dB or less for frequencies across the RFID spectrum (i.e., 860-960 MHz). It will be appreciated that the cross dipole elements of the antenna structure 14 allows for transmission and receipt of circularly-polarized signals at an AR that are approximately ideal (e.g., about 1 dB) for the RFID frequency band. As a result, based on the characteristics of the RFID tag 10 in receiving and transmitting the circularly-polarized interrogation and response signals 54 and 56, respectively, the attributes of the RFID system 10 can be substantially improved relative to many existing RFID tags. Specifically, read and write range can be substantially increased, and orientation losses, polarization losses, and tag backscatter losses can be substantially mitigated.

Referring back to the example of FIG. 1, to achieve the circular polarization characteristics, the antenna structure 14 includes a first antenna element 18 and a second antenna element 20 that can each be substantially configured as dipoles. Each of the first and second dipole antenna elements 18 and 20 can also be arranged orthogonal with respect to each other. Furthermore, the first and second antenna elements 18 and 20 can be collectively configured as a phase-shift network, such that an electric field of the each of the first and second antenna elements 18 and 20 can be shifted electrically by approximately 90° relative to each other. As an example, one of the first and second antenna elements 18 and 20 can include a delay element, such as an inductive element, to delay the current flow through the respective one of the first and second antenna elements 18 and 20 to generate the desired phase-shift. As a result, circularly-polarized RF interrogation signals can induce a rotating electric field in the antenna structure 14, and RF response signals can be transmitted as circularly-polarized signals with an AR of 5 dB or less back to the RFID reader.

Because the 90° phase-shift between the first and second antenna elements 18 and 20 is provided in the antenna structure 14, and because the antenna structure 14 is coupled to the IC 12 via a single I/O port 16, the antenna structure 14 also includes a power combiner element 22. The power combiner element 22 is configured to provide an interface for the energy of the first and second antenna elements 18 and 20 and the IC 12. As an example, the power combiner element 22 can be a Wilkinson-type power combiner, such that the ports between the first and second antenna elements 18 and 20 and the IC 12 are substantially isolated and matched. Thus, the power combiner element 22 combines the collected energy from each of the first and second antenna elements 18 and 20 and provide it to the single I/O port 16. Similarly, the combiner 22 can equally distribute the energy of an RF response signal from the IC 12 via the I/O port 16 to each of the first and second antenna elements 18 and 20 for generating corresponding circularly-polarized electromagnetic waves. The first and second antenna elements 18 and 20 and the power combiner element 22 can all be formed as a substantially monolithic (or integral) structure. For instance, the antenna elements and the power combiner element 22 can all be manufactured as a planar integrated structure of an electrically-conductive material. Therefore, the antenna structure 14 can be configured as a planar RFID antenna, such that the first and second antenna elements 18 and 20 and the power combiner element 22 are all substantially coplanar. As a result, the RFID tag 10 can benefit from a substantially compact, flat form-factor.

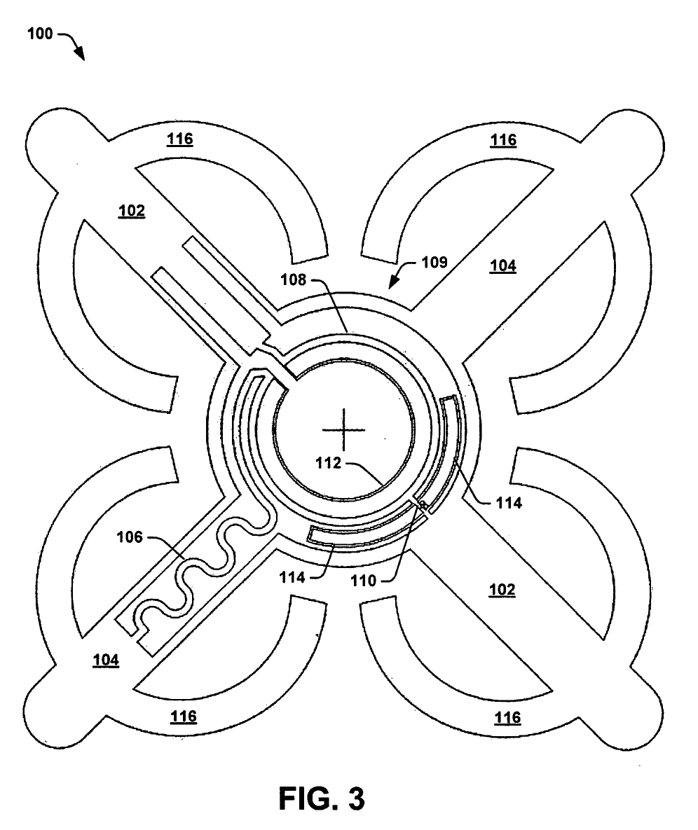

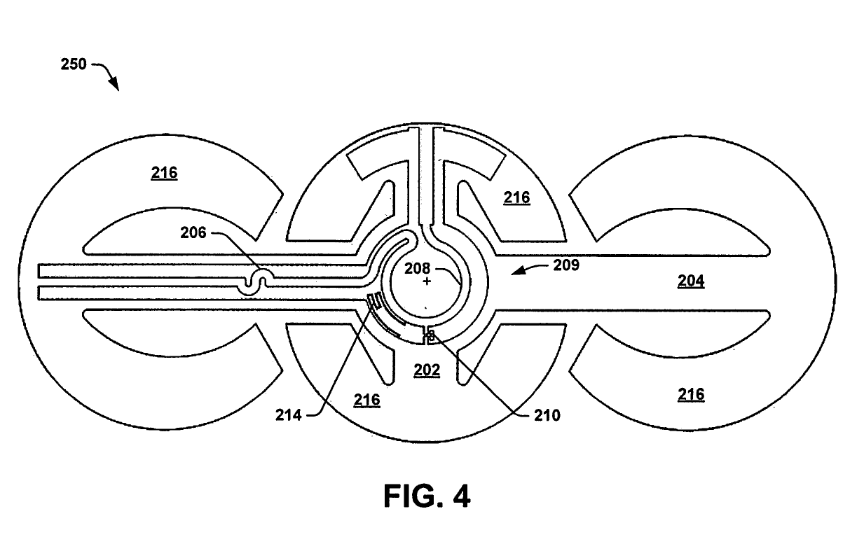

As demonstrated in the examples of FIGS. 3 and 4, the first and second antenna elements 18 and 20 and the power combiner element 22 can include one or more additional parasitic circuit elements. For example, each of the first and second antenna elements 18 and 20 can include capacitive elements to provide a distributed capacitance for broadening the operation frequency bandwidth of the antenna structure 14. As an example, the antenna structure 14 can be configured (e.g., with a capacitance and an inductance) for resonance over a desired frequency bandwidth, such as the entire RFID frequency spectrum of approximately 860 MHz to approximately 960 MHz. As another example, the power combiner element 22 can include a load resistor element and/or inductive elements to provide matched impedance between the power combiner element 22 and the antenna elements 18 and 20. As a result, the power combiner element 22 can efficiently receive and deliver the RF signals between the first and second antenna elements 18 and 20 and the IC 12 based on minimizing signal reflections.

FIG. 3 illustrates an example of an RFID antenna structure 100 in accordance with an aspect of the invention. The RFID antenna structure 100 includes a first antenna element 102 and a second antenna element 104. The first and second antenna elements 102 and 104 are configured substantially as dipoles that are arranged orthogonal and coplanar relative to each other.

In the example of FIG. 3, the second antenna element 104 includes an inductive element 106. The inductive element 106 is configured as a delay element for current through the second antenna element 104. Specifically, as a result of the inductive element 106, current through the second antenna element 104 lags behind the voltage induced by a received RF signal. Therefore, the effective electrical length of the second antenna element 104 becomes approximately twice that of the electrical length of the first antenna element 102. Accordingly, current through both the first and second antenna elements 102 and 104 can vary as a function of rotation of the incident field of a received circularly-polarized RF interrogation signal. Furthermore, due to reciprocity, an RF response signal transmitted via the RFID antenna structure is likewise subject to the current lag caused by the inductive element 106, resulting in an approximate 90° phase-shift characteristic of a circularly-polarized transmitted signal.

The RFID antenna structure 100 also includes a power combiner element 108, which is configured as an approximately central portion 109 of the antenna having a substantially circular configuration. Each of the first and second antenna elements 102 and 104 include respective portions on diametrically opposed sides of the approximately circular central portion 109. The power combiner element 108 is coupled to both of the first and second antenna elements 102 and 104, as well as an antenna feed I/O port 110 to which an IC (not shown) is coupled at a respective I/O port. The power combiner element 108 can be configured as a Wilkinson power combiner, for example. As described above, the power combiner element 108 thus provides an interface for the energy of the first and second antenna elements 102 and 104 and the respective IC, which is coupled to the antenna structure via a single port.

In the example of FIG. 3, the RFID antenna structure 100 includes a load resistor element 112 interconnecting the junction of the power combiner element 108 with each of the first and second antenna elements 102 and 104. The load resistor element 112 can contribute an amount of resistance (e.g., 70Ω) to provide a substantially matched impedance for the power combiner element 108 with respect to the first and second antenna elements 102 and 104. The load resistor element 112 can be fabricated at a specific width to provide the appropriate amount of resistance, which could be an amount of resistance that is approximately equal to twice a characteristic impedance of the power combiner element 108.

In addition, the RFID antenna structure 100 includes two additional inductive elements 114 configured on either side of the antenna feed port 110. The inductive elements 114 can be configured to provide a fine-adjustment to a matched impedance between the power combiner element 108 and the IC to which the antenna structure is coupled. Specifically, the inductive elements 114 can be fabricated to provide an impedance that is centered on a geometrical mean frequency of operation of the IC. As a result, the impedance of the RFID antenna structure 100 provides a conjugate match to the IC at the approximate center of the frequency band of operation of the IC.

At an approximate end-portion of each of the first and second antenna elements 102 and 104, the RFID antenna structure 100 includes a capacitive element 116. In the example of FIG. 3, the capacitive elements 116 are demonstrated as including semi-circular legs extending from each of the first and second antenna elements 102 and 104. For example, each of the legs can be provided as symmetrical pairs of legs that extend arcuately from opposed side edges of each respective antenna element (adjacent the distal end of the antenna elements) and curve back toward the central portion 112. The capacitive elements 116 are each configured to provide a distributed capacitance for broadening the operational frequency bandwidth of the RFID antenna structure 100. As an example, the distributed capacitance and inductance of the RFID antenna structure 100 can be configured to provide for resonance across a desired frequency range, such as the RFID frequency spectrum ranging from approximately 860 MHz to approximately 960 MHz. That is, based on the combination of the power combiner element 108, the load resistor element 112, the inductive elements 114, and the capacitive elements 116, the RFID antenna structure 100 can be configured with an impedance to resonate across substantially the entire 860-960 MHz frequency band of interest.

In the example of FIG. 3, the RFID antenna structure 100 can be fabricated as substantially planar structure, such that all of the above described elements of the RFID antenna structure 100 are substantially coplanar with respect to each other. However, it is to be understood that the RFID antenna structure 100 can be configured in any of a variety of additional manners to provide performance suitable for a given application. As an example, the width of the fabricated traces for any of the above described elements of the RFID antenna structure 100 can be formed thinner or thicker relative to that demonstrated in the example of FIG. 3 to change the resonating properties of the RFID antenna structure 100. As such, the RFID antenna structure 100 can be fabricated to resonate in only a portion of the 860-960 MHz frequency band or in another frequency band of interest.

In addition, the RFID antenna structure 100 can be configured with different dimensions and in a different configuration (e.g., having a different form factor) than that demonstrated in the example of FIG. 3 to achieve substantially similar performance. FIG. 4 illustrates another example of an RFID antenna structure 150 in accordance with an aspect of the invention. The RFID antenna structure 150 can include substantially similar components as that demonstrated in the example of FIG. 3, but can maintain substantially the same resonating properties. As such, like reference numbers, increased by adding 100, have been used in the example of FIG. 4 to identify corresponding parts to those introduced in the example of FIG. 3 to identify substantially similar components. Furthermore, the configuration of the example of FIG. 4 is such that some of the substantially similar components have been obviated, such as the load resistor element 112, and can be fabricated in a different form-factor (e.g., 88×88 mm in the example of FIG. 3, 92×36 mm in the example of FIG. 4). Accordingly, it is to be understood that the RFID antenna structures 100 and 150 in the example of FIGS. 3 and 4 can be configured in any of a variety of ways, which can vary according to application requirements.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. An antenna structure for a passive radio-frequency identification (RFID) tag, the antenna structure comprising:
a first planar antenna element; and
a second planar antenna element being coplanar with the first planar antenna element, the first and second planar antenna elements being configured to propagate circularly-polarized electromagnetic signals with an axial ratio (AR) of less than 5 dB.

2. The antenna structure of claim 1, further comprising:
a power combiner element coupled to each of the first and second planar antenna elements; and
an input/output (I/O) port electrically coupled with the power combiner element and configured to connect the antenna structure to an associated integrated circuit of the passive RFID tag, the power combiner element combining electromagnetic signals received at first and second planar antenna elements and providing combined electromagnetic signals to the I/O port, the power combiner also distributing a generated RF signal received via the I/O port from the associated integrated circuit to radiate a corresponding circularly-polarized electromagnetic signal through the first and second planar antenna elements.

3. The antenna structure of claim 2, wherein the power combiner element is configured as a Wilkinson power combiner.

4. The antenna structure of claim 2, wherein the first planar antenna element, the second planar antenna element, the power combiner element and the I/O port comprise a substantially planar electrically conductive material.

5. The antenna structure of claim 2, further comprising a load resistor element configured to provide a matched impedance between the first and second planar antenna elements and the power combiner element.

6. The antenna structure of claim 2, further comprising at least one inductive element interconnecting the power combiner element and the I/O port and configured to provide a fine adjustment to the matched impedance between the power combiner element and the I/O port across a resonant frequency bandwidth associated with the circularly-polarized electromagnetic signals.

7. The antenna structure of claim 1, wherein the first planar antenna element and the second planar antenna element are each configured as cross dipole elements of the antenna structure configured to propagate electromagnetic signals in the respective first and second planar antenna elements with an approximately 90° phase-shift.

8. The antenna structure of claim 7, wherein one of the first and second planar antenna elements comprises an inductive element that is configured to provide the approximately 90° phase-shift.

9. The antenna structure of claim 8, wherein each of the first planar antenna element and the second planar antenna element comprises at least one capacitive element configured to cooperate with the inductive element to provide for resonance at a predetermined frequency bandwidth associated with the circularly-polarized electromagnetic signals.

10. A passive RFID tag comprising the antenna structure of claim 1 for use in an RFID system, which comprises the antenna structure of claim 1 coupled to an RF integrated circuit (IC) via a single input/output port.

11. An antenna structure for a passive radio-frequency identification (RFID) tag, the antenna structure comprising:
a first dipole antenna element;
a second dipole antenna element that is substantially coplanar with and arranged orthogonal to the first dipole antenna element, the second dipole antenna element being configured to provide an approximately 90° phase-shift of transmitted and received radio frequency (RF) signals relative to the first dipole antenna element; and
a power combiner element configured as an interface interconnecting the first and second dipole antenna elements and an RF input/output (I/O) port of the antenna structure.

12. The antenna structure of claim 11, wherein one of the first dipole antenna element and the second dipole antenna element comprises an inductive element that is configured to provide the approximately 90° phase-shift.

13. The antenna structure of claim 11, wherein the first antenna element, the second antenna element, and the power combiner element are comprise a monolithic and substantially planar sheet of an electrically conductive material.

14. The antenna structure of claim 11, further comprising a load resistor element configured to provide a matched impedance at an interface of the first and second antenna elements and the power combiner element.

15. The antenna structure of claim 11, wherein each of the first dipole antenna element and the second dipole antenna element comprises at least one capacitive element configured to provide resonance at frequency bandwidth associated with RF signals in a range from approximately 860 MHz to approximately 960 MHz.

16. The antenna structure of claim 11, wherein the power combiner element further comprises a central portion of the antenna structure, such that each of the first and second dipole antenna elements comprise a respective first portion and a respective second portion that extend radially outwardly from the central portion of the antenna structure in a substantially diametrically opposed relationship from each other relative to the substantially central portion of the antenna structure.

17. A passive RFID tag comprising the antenna structure of claim 16 for use in an RFID system.

18. A radio frequency identification (RFID) transponder comprising:
a substantially planar antenna structure comprising:
a phase-shift network that includes at least one pair of cross dipole antenna elements configured to propagate a circularly-polarized electromagnetic signals with an axial ratio (AR) of less than about 5 dB; and
a power combiner connected to each of the at least one pair of cross dipole antenna elements to provide an interface between the substantially planar antenna structure and an input/output (I/O) port of the substantially planar antenna structure; and
an integrated circuit (IC) comprising a single I/O port that is electrically coupled with the I/O port of the substantially planar antenna structure, the IC being configured to send and receive RF signals relative to the substantially planar antenna structure via the single I/O port thereof which propagate as the circularly-polarized electromagnetic signals in the substantially planar antenna structure.

19. The RFID transponder of claim 18, wherein the at least one pair of cross dipole antenna elements further comprises a first dipole antenna element and a second dipole antenna element extending radially outwardly from the power combiner, the power combiner being located at a central location of the antenna structure, at least one of the first dipole antenna element and the second dipole antenna element further comprising an inductive element to provide an approximately 90° phase-shift for signals propagating in the first dipole antenna element relative to the second dipole antenna element.

20. The RFID transponder of claim 19, wherein each of the first dipole antenna element and the second dipole antenna element further comprises a capacitive element that cooperates with at least one inductive element to provide for resonance over a predetermined frequency band ranging from approximately 860 MHz to approximately 960 MHz.
